(19) United States
(12) Patent Application Publication
(10) Pub. No.: US 2020/0133619 A1
(43) Pub. Date: Apr. 30, 2020

(54) SYSTEM AND METHOD FOR DETECTING, ESTIMATING, AND COMPENSATING ACOUSTIC DELAY IN HIGH LATENCY ENVIRONMENTS

(71) Applicant: Drivetime, Inc., San Francisco, CA (US)

(72) Inventor: Nicholas Cory JOHNSON, San Francisco, CA (US)

(21) Appl. No.: 16/171,175

(22) Filed: Oct. 25, 2018

(51) Int. Cl. G06F 3/16; G06N 7/00

(52) U.S. Cl. CPC G06F 3/16; G06N 7/005

(57) ABSTRACT

Systems and methods for detecting, estimating, and compensating acoustic delay in high latency environments are disclosed. A particular embodiment includes: receiving an audio output signal (OS) from a media system and passing the audio output signal (OS) to an audio buffer; receiving an audio input signal (IS) from an input system and passing the audio input signal (IS) to the audio buffer; converting the audio output signal (OS) and the audio input signal (IS) appropriately for comparison; comparing the converted audio output signal (OS) with the converted audio input signal (IS) to determine a probability and intensity of audio signal overlap between the converted audio output signal (OS) and the converted audio input signal (IS); generating audio overlap data (OD) from the probability and intensity of audio signal overlap, the audio overlap data (OD) representing a magnitude and offset of the audio signal overlap; and using the audio overlap data (OD) to perform an audio signal compensation function on the audio input signal (IS).

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2017-2018, Drivetime, Inc., All Rights Reserved.

### TECHNICAL FIELD

This patent document pertains generally to audio systems, home or vehicle media systems, high latency audio environments, and more particularly, but not by way of limitation, to a system and method for detecting, estimating, and compensating acoustic delay in high latency environments.

### BACKGROUND

When a user participates in an audio experience with a media system and a separate speaker (e.g., a vehicle stereo system), there can be noticeable delay between the time the media system (e.g., a mobile phone, tablet, vehicle on-board computer or infotainment system, etc.) sends an output audio signal and the time the audio signal is actually played out loud by the speaker. This delay can produce the effect of extreme “desync” or desynchronization (e.g., the mobile phone is displaying graphics but the audio being heard by the user no longer matches those graphics). If there is a microphone in the media system (e.g., the mobile phone's microphone), then the delay might cause the user to experience “echo” as well. For example, if the mobile phone tries to output the audio signal received from the microphone, the extreme delay will cause any audio signal to repeat infinitely. In separate speaker audio environments (e.g., using a car stereo or a home Bluetooth™ speaker) the delay or latency is often severe enough that traditional methods of “cancelling” audio signal echo are not effective in resolving either of these problems. The traditional methods for attenuating or “cancelling” audio signal echo may be effective for real-time signals in low latency environments (e.g., teleconferencing systems, VoIP, etc.). However, these traditional methods are ill-suited to handling audio echo in high latency environments. In particular, there are situations where the “echo” audio signal is not received by the input system (e.g., a microphone) until multiple seconds after the audio signal is sent by the media system (e.g., a mobile phone) to the output system to be played (e.g., by high quality wireless vehicle or home speakers). The high amount of latency found in these environments renders traditional methods of echo cancellation unusable because of their inability to handle extreme latency while still meeting performance requirements in real-time applications.

### SUMMARY

A system and method for detecting, estimating, and compensating acoustic delay in high latency environments are disclosed. The example embodiments disclosed herein are configured to detect, estimate, and compensate for desync and echo in dynamic high latency audio environments. The system and method can reduce and/or eliminate both desync and echo in these audio environments. In an example embodiment, the microphone remains active while the system retains and stores the last X (e.g., five) seconds of the audio signal being sent to the speakers (denoted the outgoing audio signal) or other output system. The system and method of the example embodiments also retain and store the last X seconds of the audio signal being received by the input system (e.g., a microphone) as the user's audio experience proceeds (denoted the incoming audio signal). In other words, the outgoing audio signals from a media system (as the audio is generated for transfer to an output system) are retained and stored. Similarly, the incoming signals received by the input system (e.g., a microphone) are retained and stored. Typically, the outgoing audio signals and the incoming audio signals contain a combination of real-time “near-end” input from the real world and delayed “far-end” output from the output system. The outgoing audio signals and the incoming audio signals are stored into separate instances of a circular audio buffer, which can be implemented as an audio signal storage structure configured to hold fixed-length windows of audio signals (e.g., the previous 5 seconds of audio signal).

The outgoing audio signal and the incoming audio signal stored in the audio buffer can be periodically compared to each other at regular intervals (e.g., every 1 second). The audio signal comparison process in an example embodiment includes using standard signal processing techniques to detect the magnitude and offset of any matching signals present in the audio buffer (e.g., both how much of a signal match is present, and how far offset that signal match is in time between the outgoing audio signal and the incoming audio signal). If the magnitude of any matching signals is high enough, desync and echo is detected. The offset is then a relatively accurate estimate of the echo delay in time (e.g., how much time it took for the audio signal to be received by the input system after the audio signal was first sent to the output system). In this manner, the example embodiments can detect the probability that some portion of the audio signal received by the microphone is overlapping and offset from the audio signal sent to the speakers for each possible offset (e.g., the probability the microphone audio is offset by 1 second, 2 seconds, 3 seconds, etc.). In various example embodiments, the described system can detect potential offsets of a granularity in the range of 1 millisecond or less to 10 seconds or more.

Once this audio signal overlap/probability is detected, the related audio overlap data (OD) can be used to augment and improve the outgoing audio signal sent to the output system (e.g., the speakers) and/or the incoming audio signal received by the input system (e.g., the microphone). For example, the unwanted audio echo can be removed or attenuated from either or both of the outgoing audio signal and the incoming audio signal. Additionally, the audio overlap data can be used by the media system (e.g., a mobile phone) or other display device to compensate for desync in the graphics produced by the media system or other display device by offsetting the displayed graphics with a delay corresponding to the audio overlap data. The audio overlap data can also be used by the media system or other audio device to compensate for desync in the audio by offsetting the incoming audio signal with a delay corresponding to the audio overlap data thereby eliminating the unwanted echo. As a result, the example embodiments can mitigate unwanted echo in a high latency environment, offset any desync in the graphics produced by a display device by applying an appropriate delay, and offset any desync or echo in the incoming audio signal by applying an appropriate delay. As such, the example embodiments can offset both future visual displays and future audio input signals by the proper echo delay estimate based on the audio overlap data detected by the example embodiments.

### BRIEF DESCRIPTION OF THE DRAWINGS

The various embodiments are illustrated by way of example, and not by way of limitation, in the figures of the accompanying drawings in which:

FIG. 1 illustrates an example embodiment of an audio signal processing system with a separate, high dynamic latency output system configured to detect, estimate, and compensate for audio signal delay;

FIGS. 2 and 3 illustrate an audio signal processing flow diagram showing the processing performed by the detection, estimation, and compensation processes controlled by the digital signal processor and the audio signal compensator of an example embodiment; and

FIG. 4 is a processing flow chart illustrating an example embodiment of a system and method for detecting, estimating, and compensating acoustic delay in high latency environments.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A system and method for detecting, estimating, and compensating acoustic delay in high latency environments are disclosed. The example embodiments disclosed herein are configured to detect, estimate, and compensate for echo in dynamic high latency audio environments. The system and method can reduce and/or eliminate both desync and echo in these audio environments. In an example embodiment, the microphone remains active while the system retains and stores the last X (e.g., five) seconds of the audio signal being sent to the speakers (denoted the outgoing audio signal) or other output system. The system of the example embodiment also retains and stores the last X seconds of the audio signal being received by the input system (e.g., a microphone) as the user's audio experience proceeds (denoted the incoming audio signal). In other words, the outgoing audio signals from a media system (as the audio is generated for transfer to an output system) are retained and stored. Similarly, the incoming signals received by the input system (e.g., a microphone) are retained and stored. Typically, the outgoing audio signals and the incoming audio signals contain a combination of real-time “near-end” input from the real world and delayed “far-end” output from the output system. The outgoing audio signals and the incoming audio signals are stored into separate instances of a circular audio buffer, which can be implemented as an audio signal storage structure configured to hold fixed-length windows of audio signals (e.g., the previous 5 seconds of audio signal).

The outgoing audio signal and the incoming audio signal stored in the audio buffer can be periodically compared to each other at regular intervals (e.g. every 1 second). The audio signal comparison process in an example embodiment includes using standard signal processing techniques to detect the magnitude and offset of any matching signals present in the audio buffer (e.g., both how much of a signal match is present, and how far offset that signal match is in time between the outgoing audio signal and the incoming audio signal). If the magnitude of any matching signals is high enough, desync and echo is detected. The offset is then a relatively accurate estimate of the echo delay in time (e.g., how much time it took for the audio signal to be received by the input system after the audio signal was first sent to the output system). In this manner, the example embodiments can detect the probability that some portion of the audio signal received by the microphone is overlapping and offset from the audio signal sent to the speakers for each possible offset (e.g., the probability the microphone audio is offset by 1 second, 2 seconds, 3 seconds, etc.).

Once this audio signal overlap/probability is detected, the related audio overlap data (OD) can be used to augment and improve the outgoing audio signal sent to the output system (e.g., the speakers) and/or the incoming audio signal received by the input system (e.g., the microphone). For example, the unwanted audio echo can be removed or attenuated from either or both of the outgoing audio signal and the incoming audio signal. Additionally, the audio overlap data can be used by the media system (e.g., a mobile phone) or other display device to compensate for desync in the graphics produced by the media system or other display device by offsetting the displayed graphics with a delay corresponding to the audio overlap data. The audio overlap data can also be used by the media system or other audio device to compensate for desync in the audio by offsetting the incoming audio signal with a delay corresponding to the audio overlap data thereby eliminating the unwanted echo. As a result, the example embodiments can mitigate unwanted echo in a high latency environment, offset any desync in the graphics produced by a display device by applying an appropriate delay, and offset any desync or echo in the incoming audio signal by applying an appropriate delay. As such, the example embodiments can offset both future visual displays and future audio input signals by the proper echo delay estimate based on the audio overlap data detected by the example embodiments.

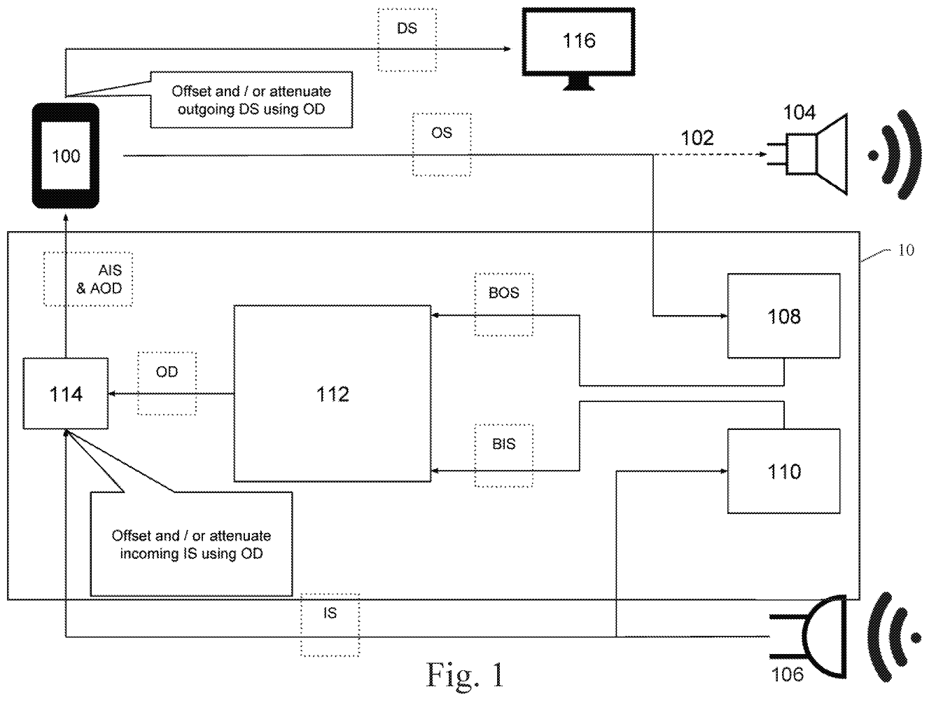

Referring now to FIG. 1, an example embodiment of an audio signal processing system 10 with a separate, high dynamic latency output system configured to detect, estimate, and compensate for audio signal delay is illustrated. As shown in FIG. 1, a media system 100 can be used to generate or provide an audio output signal (OS) and a display signal or data signal (DS), which can be provided to a display device 116 to render a graphical information display, such as an album/song title or the like. In other embodiments, the display device 116 can represent the media system device display screen, which can render all the relevant graphics for a game or other media experience. The media system 100 can be a conventional audio output and display device, such as a mobile phone, MP3 player, vehicle or home entertainment system, or the like. In a typical operation of the media system 100, the media system 100 can begin the process by generating the audio output signal (OS) and corresponding display signal (DS). The audio output signal (OS) is typically sent to a speaker 104 or other output system and audibly rendered for a user. However, the audio output signal (OS) may be subject to a variable amount of high latency 102 before the speaker 104 can actually render the audio signal.

To detect and compensate for this high latency 102, the example embodiment includes an audio signal processing system 10, which includes audio buffers 108 and 110, a digital signal processor 112, and an audio signal compensator 114. Each of these audio signal processing system 10 components are described in more detail below in connection with FIGS. 1 through 3.

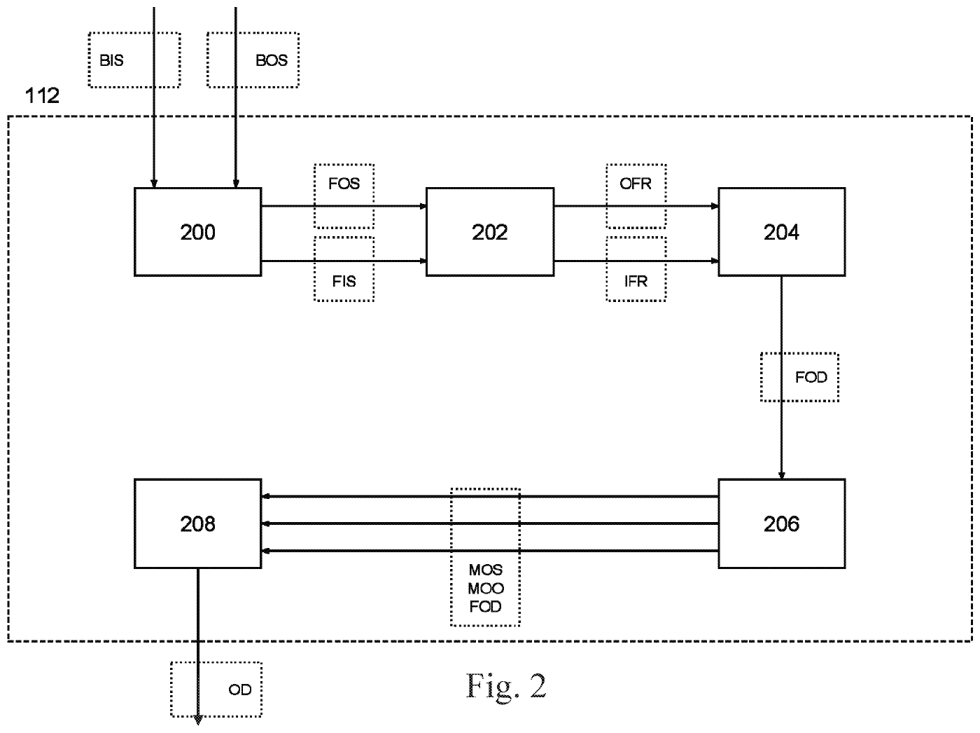

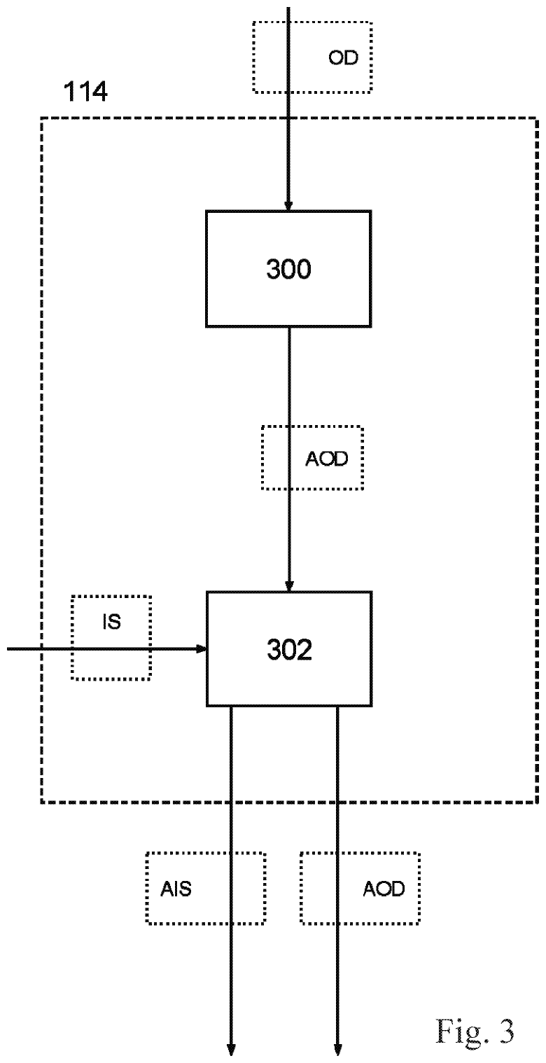

Referring again to FIG. 1, the media system 100 sends the audio output signal (OS) to speakers 104. The audio signal processing system 10 is configured to receive the audio output signal (OS) and pass the audio output signal (OS) to audio buffer 108. As described above, audio buffer 108 can be implemented as a circular audio buffer or an audio signal storage structure configured to hold fixed-length windows of audio signals (e.g., the previous 5 seconds of audio signal). As shown in FIG. 1, the audio signal processing system 10 is also configured to receive an audio input signal (IS) from an input system (e.g., a microphone) 106. The audio signal processing system 10 can pass the received audio input signal (IS) to audio buffer 110. The audio buffer 110 can also be implemented as a circular audio buffer or an audio signal storage structure configured to hold fixed-length windows of audio signals (e.g., the previous 5 seconds of audio signal). In an example embodiment, the audio buffers 108 and 110 can be implemented as a single partitioned audio buffer. The audio signal processing system 10 can also pass the received audio input signal (IS) to the audio signal compensator 114 described in detail below in connection with FIG. 3. As shown in FIG. 1, the digital signal processor 112 is configured to receive the buffered input signal (BIS) from the audio buffer 110 and to receive the buffered output signal (BOS) from the audio buffer 108. The digital signal processor 112 can be implemented as a standard digital signal processor programmed to perform the audio signal processing operations as described in detail below in connection with FIG. 2.

FIG. 2 illustrates an audio signal processing flow diagram showing the processing performed by the digital signal processor 112 of an example embodiment. As described above, the digital signal processor 112 receives the buffered input signal (BIS) from the audio buffer 110 and the buffered output signal (BOS) from the audio buffer 108. The buffered input signal (BIS) and the buffered output signal (BOS) are passed to a signal converter 200. The signal converter 200 performs any format conversion, resampling, stereo/mono conversion, or the like that may be required to align both signals (BIS and BOS) in the same format. The signal converter 200 formats the buffered output signal (BOS) into a formatted output signal (FOS). The signal converter 200 also formats the buffered input signal (BIS) into a formatted input signal (FIS). The resulting formatted output signal (FOS) and formatted input signal (FIS) are then passed to a frequency analyzer 202. The frequency analyzer 202 is configured to convert the formatted audio signals (FOS and FIS) into different mathematical frequency representations (e.g., Fast Fourier Transforms) if the frequency analyzer 202 determines that such frequency representations will result in better performance. The frequency analyzer 202 converts the formatted output signal (FOS) into an output frequency representation (OFR). The frequency analyzer 202 also converts the formatted input signal (FIS) into an input frequency representation (IFR). The resulting output frequency representation (OFR) and input frequency representation (IFR), which have been converted appropriately for comparison, are then passed to an estimator 204. The estimator 204 compares the two frequency representations (OFR and IFR) to determine a frequency overlap distribution (FOD), which describes the probability and intensity of audio signal overlap for each potential offset of the buffered input signal (BIS) and the buffered output signal (BOS). The frequency overlap distribution (FOD) is then passed to a distribution analyzer 206. The distribution analyzer 206 processes the frequency overlap distribution (FOD) to determine the maximum overlap strength (MOS) and the maximum overlap offset (MOO). The maximum overlap strength (MOS) and the maximum overlap offset (MOO) together describe the most likely candidate for a signal overlap between the buffered input signal (BIS) and the buffered output signal (BOS). The maximum overlap strength (MOS) and the maximum overlap offset (MOO) together with the frequency overlap distribution (FOD) are then passed to a formatter 208. The formatter 208 formats the MOS, MOO, and FOD data together into a set of audio overlap data (OD), which represents the magnitude and offset of the matching audio signals from the buffered audio signals (BIS and BOS). Thus, the audio overlap data (OD) corresponds to the acoustic delay detected and estimated in a high latency audio environment. The formatter 208 passes the audio overlap data (OD) to the compensator 114 as described in detail below in connection with FIG. 3.

FIG. 3 illustrates an audio signal processing flow diagram showing the processing performed by the compensator 114 of an example embodiment. As described above, the compensator 114 receives the audio overlap data (OD) generated by the digital signal processor 112. The audio overlap data (OD) represents the magnitude and offset of the matching audio signals from the buffered audio signals (BIS and BOS), which corresponds to the acoustic delay detected and estimated in a high latency audio environment. The compensator 114 of an example embodiment is configured to use the audio overlap data (OD) to compensate for the detected acoustic delay, thereby improving the audio experience for the user. When the compensator 114 receives a current set of audio overlap data (OD) from the digital signal processor 112, the compensator 114 may use a list or dataset of known output device characteristics 300 to modify the audio overlap data (OD) in a manner corresponding to the known output device characteristics 300. As a result, the compensator 114 can generate adjusted audio overlap data (AOD), which can be passed to a signal compensator 302. The signal compensator 302 can also be configured to receive the audio input signal (IS) from an input system (e.g., a microphone) 106 as shown in FIG. 1. Given the processing performed by the digital signal processor 112 and the compensator 114, the characteristics of the acoustic delay detected in the audio input signal (IS) have been determined and represented as the adjusted audio overlap data (AOD). As such, the signal compensator 302 can use the adjusted audio overlap data (AOD) to perform a variety of audio signal compensation functions on the audio input signal (IS) to respond to the presence of the acoustic delay or echo detected and estimated in the audio input signal (IS). In one example, the signal compensator 302 can use the adjusted audio overlap data (AOD) to offset the audio input signal (IS) by an amount corresponding to the adjusted audio overlap data (AOD). As a result, the adjusted audio input signal (AIS) is essentially synced with the audio output signal (OS). The adjusted audio input signal (AIS) along with the adjusted audio overlap data (AOD) can be passed to the media system 100. In another example, the signal compensator 302 can use the adjusted audio overlap data (AOD) to attenuate or suppress the offset audio input signal (IS). In this manner, the echo caused by the offset audio input signal (IS) can be removed. In yet another example, the signal compensator 302 can use the adjusted audio overlap data (AOD) to determine if the acoustic delay or echo detected and estimated in the audio input signal (IS) is significant enough to perform any audio signal compensation functions on the audio input signal (IS). For example, if the adjusted audio overlap data (AOD) indicates an acoustic delay or echo that is below or within a pre-defined threshold, the signal compensator 302 can pass the audio input signal (IS) to the media system 100 without modification. Otherwise, an audio signal compensation function can be applied to the audio input signal (IS).

As described above and shown in FIG. 1, the media system 100 can receive the adjusted audio input signal (AIS) and the adjusted audio overlap data (AOD) from the audio signal processing system 10. The media system 100 may also use the adjusted audio overlap data (AOD) to adjust any display or data signal (DS) the media system 100 may be generating for display on a display device 116. In one example, the media system 100 can use the adjusted audio overlap data (AOD) to offset the display or data signal (DS) by an amount corresponding to the adjusted audio overlap data (AOD). As a result, the display or data signal (DS) is essentially synced with the audio output signal (OS). In another example, the media system 100 can use the adjusted audio overlap data (AOD) to suppress the desynced display or data signal (DS). In this manner, the desynced display data caused by the offset audio input signal (IS) can be removed. In yet another example, the media system 100 can use the adjusted audio overlap data (AOD) to determine if the acoustic delay or echo detected and estimated in the audio input signal (IS) is significant enough to perform any display or data signal (DS) compensation functions or audio signal compensation functions. For example, if the adjusted audio overlap data (AOD) indicates an acoustic delay or echo that is below or within a pre-defined threshold, the media system 100 can pass the display or data signal (DS) to the display device 116 without modification. Otherwise, a display or data signal (DS) compensation function can be applied to the display or data signal (DS). As a result, the user experience with regard to the display device 116 can be improved by use of the audio signal processing system 10 as described herein. Thus, a system and method for detecting, estimating, and compensating acoustic delay in high latency audio environments are disclosed.

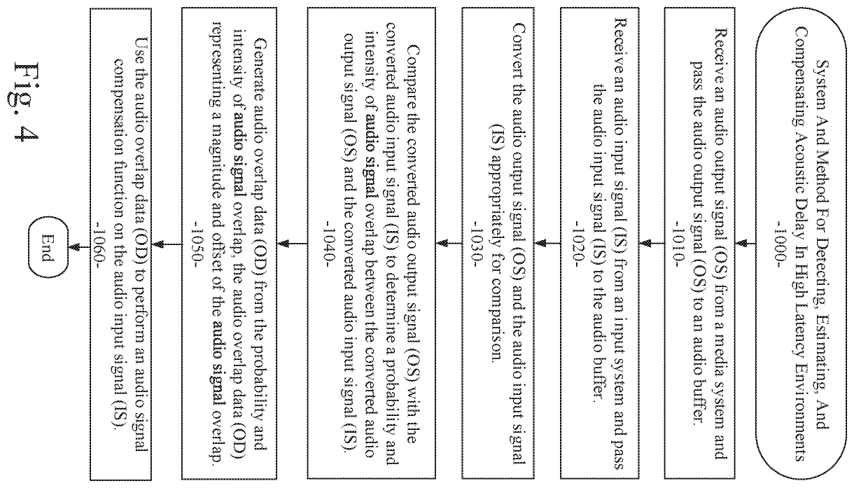

FIG. 4 is a processing flow diagram illustrating an example embodiment of the systems and methods for detecting, estimating, and compensating acoustic delay in high latency environments as described herein. The method 1000 of an example embodiment includes: receiving an audio output signal (OS) from a media system and passing the audio output signal (OS) to an audio buffer (processing block 1010); receiving an audio input signal (IS) from an input system and passing the audio input signal (IS) to the audio buffer (processing block 1020); converting the audio output signal (OS) and the audio input signal (IS) appropriately for comparison (processing block 1030); comparing the converted audio output signal (OS) with the converted audio input signal (IS) to determine a probability and intensity of audio signal overlap between the converted audio output signal (OS) and the converted audio input signal (IS) (processing block 1040); generating audio overlap data (OD) from the probability and intensity of audio signal overlap, the audio overlap data (OD) representing a magnitude and offset of the audio signal overlap (processing block 1050); and using the audio overlap data (OD) to perform an audio signal compensation function on the audio input signal (IS) (processing block 1060).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method comprising:
receiving an audio output signal (OS) from a media system and passing the audio output signal (OS) to an audio buffer;
receiving an audio input signal (IS) from an input system and passing the audio input signal (IS) to the audio buffer;
converting the audio output signal (OS) and the audio input signal (IS) for comparison;
comparing the converted audio output signal (OS) stored in the audio buffer with the converted audio input signal (IS) stored in the audio buffer to determine a probability and intensity of audio signal overlap between the converted audio output signal (OS) and the converted audio input signal (IS), the comparing using signal processing to detect a magnitude and offset of any matching signals present in the audio buffer;
generating audio overlap data (OD) from the probability and intensity of audio signal overlap, the audio overlap data (OD) representing a magnitude and offset of the audio signal overlap; and
using the audio overlap data (OD) to perform an audio signal compensation function on the audio input signal (IS).

2. The method of claim 1 wherein the audio overlap data (OD) includes a maximum overlap strength (MOS) and a maximum overlap offset (MOO).

3. The method of claim 1 wherein the audio signal compensation function causes an offset to be applied to the audio input signal (IS), the offset corresponding to the audio overlap data (OD).

4. The method of claim 1 wherein the audio signal compensation function causes the audio input signal (IS) to be suppressed or attenuated.

5. The method of claim 1 including passing the audio overlap data (OD) and the audio input signal (IS), modified by the audio signal compensation function, to the media system.

6. The method of claim 5 including causing the media system to apply an offset to a display or data signal, the offset corresponding to the audio overlap data (OD).

7. The method of claim 1 including using a list or dataset of known output device characteristics to modify the audio overlap data (OD) in a manner corresponding to the known output device characteristics.

8. The method of claim 1 wherein the audio buffer is configured to store at least the previous one second of the audio output signal (OS) and the audio input signal (IS).

9. The method of claim 1 wherein converting the audio output signal (OS) and the audio input signal (IS) appropriately for comparison includes converting the audio output signal (OS) or the audio input signal (IS) into different mathematical frequency representations.

10. An audio signal processing system comprising:
a digital signal processor;
an audio buffer coupled to the digital signal processor;
an audio signal compensator coupled to the digital signal processor;
the audio signal processing system being configured to:
receive an audio output signal (OS) from a media system and pass the audio output signal (OS) to the audio buffer;
receive an audio input signal (IS) from an input system and pass the audio input signal (IS) to the audio buffer;
use the digital signal processor to convert the audio output signal (OS) and the audio input signal (IS) for comparison, compare the converted audio output signal (OS) stored in the audio buffer with the converted audio input signal (IS) stored in the audio buffer to determine a probability and intensity of audio signal overlap between the converted audio output signal (OS) and the converted audio input signal (IS), the comparing using signal processing to detect a magnitude and offset of any matching signals present in the audio buffer, and generate audio overlap data (OD) from the probability and intensity of audio signal overlap, the audio overlap data (OD) representing a magnitude and offset of the audio signal overlap; and
use the audio signal compensator to use the audio overlap data (OD) to perform an audio signal compensation function on the audio input signal (IS).

11. The audio signal processing system of claim 10 wherein the audio overlap data (OD) includes a maximum overlap strength (MOS) and a maximum overlap offset (MOO).

12. The audio signal processing system of claim 10 wherein the audio signal compensation function causes an offset to be applied to the audio input signal (IS), the offset corresponding to the audio overlap data (OD).

13. The audio signal processing system of claim 10 wherein the audio signal compensation function causes the audio input signal (IS) to be suppressed or attenuated.

14. The audio signal processing system of claim 10 being further configured to pass the audio overlap data (OD) and the audio input signal (IS), modified by the audio signal compensation function, to the media system.

15. The audio signal processing system of claim 14 being further configured to cause the media system to apply an offset to a display or data signal, the offset corresponding to the audio overlap data (OD).

16. The audio signal processing system of claim 10 being further configured to use a list or dataset of known output device characteristics to modify the audio overlap data (OD) in a manner corresponding to the known output device characteristics.

17. The audio signal processing system of claim 10 wherein the audio buffer is configured to store at least the previous one second of the audio output signal (OS) and the audio input signal (IS).

18. The audio signal processing system of claim 10 being further configured to convert the audio output signal (OS) or the audio input signal (IS) into different mathematical frequency representations.

19. A non-transitory machine-useable storage medium embodying instructions which, when executed by a machine, cause the machine to:
receive an audio output signal (OS) from a media system and pass the audio output signal (OS) to an audio buffer;
receive an audio input signal (IS) from an input system and pass the audio input signal (IS) to the audio buffer;
convert the audio output signal (OS) and the audio input signal (IS) for comparison;
compare the converted audio output signal (OS) stored in the audio buffer with the converted audio input signal (IS) stored in the audio buffer to determine a probability and intensity of audio signal overlap between the converted audio output signal (OS) and the converted audio input signal (IS), the comparing using signal processing to detect a magnitude and offset of any matching signals present in the audio buffer;
generate audio overlap data (OD) from the probability and intensity of audio signal overlap, the audio overlap data (OD) representing a magnitude and offset of the audio signal overlap; and
use the audio overlap data (OD) to perform an audio signal compensation function on the audio input signal (IS).

20. The non-transitory machine-useable storage medium of claim 19 wherein the audio signal compensation function causes an offset to be applied to the audio input signal (IS), the offset corresponding to the audio overlap data (OD).
